(19) United States
(12) Patent Application Publication
(10) Pub. No.: US 2025/0390090 A1
(43) Pub. Date: Dec. 25, 2025

(54) MONITORING DEVICE FOR MONITORING THE CONDITION OF A MACHINE

(71) Applicant: Siemens Aktiengesellschaft, München (DE)

(72) Inventors: Johanna Bronner, München (DE); Alexander Michael Gigler, Untermeitingen (DE); Sebastian Mittelstädt, Gundelfingen a.d. Donau (DE); Cecilia Margareta Bruhn, München (DE); Johannes Kehrer, München (DE); Andreas Hangauer, München (DE)

(21) Appl. No.: 18/879,155

(22) PCT Filed: Jun. 16, 2023
(86) PCT No.: PCT/EP2023/066285

§ 371 Date: Dec. 26, 2024

(30) Foreign Application Priority Data
Jun. 29, 2022 (EP) 22181927.9

(51) Int. Cl. G05B 23/02

(52) U.S. Cl. CPC G05B 23/0254; G05B 23/0216; G05B 23/0262

(57) ABSTRACT

The invention relates to a device for monitoring the condition of a machine (10), comprising (20):—a machine learning unit (21) designed to receive sensor data which is collected on the machine (10) during ongoing operation and which comprises at least one parameter of the machine (10), to determine an anomaly outcome on the basis of the sensor data and to provide to a transfer unit (22) at least one attribute justifying the anomaly outcome;—the transfer unit (22) which is designed to determine at least one indicator within the sensor data for the anomaly outcome on the basis of the at least one attribute and to provide to an interpretation unit (23) the at least one indicator; and—the interpretation unit (23) which is designed to verify the anomaly outcome on the basis of the at least one indicator and guidelines containing rules that comprise at least one allocation of indicators to error types of the machine (10) and, in the event of a positive anomaly outcome confirming an anomaly, to output a control instruction to be performed on the machine.

### CROSS-REFERENCE TO RELATED APPLICATIONS

This application is a national stage of PCT Application No. PCT/EP2023/066285, having a filing date of Jun. 16, 2023, which claims priority to EP Application No. 22181927.9, having a filing date of Jun. 29, 2022, the entire contents both of which are hereby incorporated by reference.

### FIELD OF TECHNOLOGY

The following relates to a monitoring device for monitoring the condition of a machine, and to a corresponding method and computer program product.

### BACKGROUND

The monitoring of industrial installations, whether for anomaly detection or for the prediction of maintenance cycles (predictive maintenance), is based either upon an optimum understanding of physical and technical context and a capability for the analytical description of the installation, or upon the availability of a sufficient volume of good and bad data which will permit the sufficiently effective training of an artificial intelligence (AI), in particular a classifier, in the form of a machine learning model.

Typical requirements for a monitoring system are a cold-start capability, i.e., the execution of semi-automatic fault detection on the installation, which is to be monitored, even in the absence of data or with a limited quantity of data, or a requirement for conclusive fault identification, which extends far beyond a warning in the form of “Caution!”. A decision to the effect that a fault is present should be reproducible, and the solution should be rapidly and flexibly transferable to “similar, but not identical” installations or devices.

A key problem arises, in that neither a sufficient technical understanding is provided for an accurate and comprehensive analytical description, nor are sufficient data available, in advance of commissioning, for the training of a ML model. In many cases, expert knowledge takes the form of a “gut feeling” or experience, or is provided in the form of generic descriptions, which can only be reconciled with actual sensor data with difficulty. Moreover, detailed knowledge of fault processes or the fault behavior of a particular type of installation are not sufficiently known.

Simulation models can provide some description of the installation, which is to be monitored and the behavior thereof, but seldom model the entirety of mutually interrelated effects, such as multiphysics-based approaches, weakly statistically correlated effects, or a temporal offset between a fault and failure. Moreover, the generation of quantitative conclusions by a simulation model is highly complex, as it is necessary to execute an accurate parameter setting of the model for each industrial installation.

Installations or production processes which are to be monitored are typically equipped with a multiplicity of sensors of different types, which deliver data of varying quality, for example signal quality, and which are supplied with various types of data streams. For example, a signal is transmitted in the form of a voltage from 0 . . . IV, or 0 . . . 10V, or −5 . . . 5V, or a current from 0 . . . 24 mA, or is present in a semantically annotated form as NUMBER+UNIT+DEGREE OF ERROR+METAINFO. Sensor data can also be configured in various data modalities, including e.g., time series, RGB 2D images, 3D topographic data, multidimensional spectral camera data, sporadic individual measurements with no fixed cycle time, event-based measurements, and many more.

### SUMMARY

An aspect relates to a device which, using limited available data for an installation, executes a semi-automatic and reproducible fault detection and outputs a meaningful fault indication, and which can also be employed for similar, but not identical installations.

According to a first aspect, embodiments of the invention relate to a device for monitoring the condition of a machine, comprising:
a machine learning unit, which receives sensor data which are collected on the machine during ongoing operation, and which comprise at least one parameter of the machine, which determines an anomaly outcome on the basis of the sensor data, and which ascertains at least one attribute in the sensor data which justifies the anomaly outcome, and executes the delivery thereof to a transfer unit:
the transfer unit, which ascertains at least one indicator within the sensor data for the anomaly outcome on the basis of the at least one attribute, and delivers the at least one indicator to an interpretation unit: and
the interpretation unit, which verifies the anomaly outcome on the basis of the at least one indicator and a guideline containing rules which comprise at least one allocation of indicators to error types of the machine and which, in the event of a positive anomaly outcome which confirms the anomaly, outputs a control instruction to be executed on the machine.

The device is divided, in a modular manner, into a data-based machine learning unit and a “physics-based” interpretation unit. The former is based upon machine learning, i.e., is conceived for data-driven methods. In this case, domain knowledge of the machine which is to be monitored is not necessary or is only required to a minimal extent. Domain knowledge, including potential anomalies, is logged in an abstracted manner by the guidelines. Logging in the form of abstract knowledge ensures that interpretation is not specific to a particular machine which is to be monitored but can be employed for an entire class of machines to which the guideline is applicable. By the combination of anomaly detection and the physical interpretation thereof, the device is service-ready for the machine which is to be monitored, and thus assumes a cold-start capability, even in the absence of any preliminary sensor data collection and data notation.

A machine can be comprised of a single component, or of a plurality of mutually separate components which, for example, execute a single production step or a plurality of production steps.

In an embodiment, the machine learning unit comprises an anomaly detection unit having a trained machine learning model which, by reference to sensor data which have been logged on the machine in normal operation during a predetermined adaptation period, further to commissioning, executes an adaptation to the machine which is currently to be monitored.

The machine learning model which is trained for anomaly detection thus delivers optimum outcomes for the machine, which is to be monitored, immediately further to the adaptation period. As sensor data are collected during a normal operation of the machine, no manual annotation/labelling, i.e., an assignment of sensor data to an operating mode of the machine is required.

In an embodiment, the machine learning model is adapted at predetermined time intervals during the operation of the machine.

The machine learning model can thus be continuously adapted to changes in the machine which occur during the operation thereof, for example as a result of wear or in response to altered external conditions.

In an embodiment, the anomaly outcome is output in the form of a binary value, which is dependent upon a calculated anomaly value, also described as an anomaly score, and a limiting value is ascertained wherein, in particular, the limiting value is established by reference to an empirical distribution of the anomaly value for non-anomaly data, or the anomaly outcome is output in the form of a weighting, which indicates a degree of prominence of the anomaly.

A flexible set-up is thus enabled, with effect from the time at which an anomaly is present.

In an embodiment, the machine learning unit comprises a data processing unit which, in a temporal sequence, receives raw data which are measured on the machine and subdivides raw data into temporal processing stages and/or converts the data format thereof and/or consolidates multiple components of raw data into a single sensor data parameter, and executes the output thereof by way of sensor data.

The data processing unit thus converts raw data, which is received in different forms and at various time intervals, into a consistent form, for example in the form of vector data.

In an embodiment, the data processing unit harmonizes a sub-volume of raw data, the input rate of which deviates from an output rate of sensor data, with the output rate.

A synchronized signal rate of all signal data is thus ensured, i.e., at any time point at which an output signal is to be calculated from sensor data, the values of all input signals are available. The output signal of the data processing unit is a vector incorporating elements which are relevant to the anomaly detection unit. The output rate assumes a fixed and stipulated value and corresponds to the rate at which anomaly detection is executed.

In an embodiment, the machine learning unit comprises an anomaly interpretation unit which, by way of an input signal, receives the anomaly outcome and sensor data for the fundamental processing stage and which, by way of attributes, outputs sensor data parameters which are sorted according to their relevance to the anomaly outcome.

By the interpretation unit, decisions of the anomaly detection unit are reproducibly represented for example by an interpretable machine learning method.

In an embodiment, the transfer unit receives sensor data for the fundamental processing stage and/or additional sensor data for the adjacent processing stage, by way of an input signal, and ascertains the at least one indicator herefrom for those attributes having the highest relevance.

Indicators essentially constitute trends vis-à-vis a good working order, i.e., the behavior of attributes such as, e.g., a substantial rise, failure, oscillation or decay.

In an embodiment, the device moreover comprises an extraction unit, which is configured to infer rules and indicators based upon expert knowledge, textbook knowledge, physical analytical description or a digital twinning of the machine, and to execute the delivery thereof to the interpretation unit, prior to commissioning.

Domain knowledge of the machine which is to be monitored, together with potential anomalies and causes of anomalies, are logged in an abstracted manner for example as an element of the interpretation unit. Logging in the form of abstract knowledge ensures that interpretation is not specific to a particular machine which is to be monitored but can be employed for those machines to which the rules are applicable, and which are thus included in a specific class of machines.

In an embodiment, the interpretation unit is configured to receive and/or update further rules and/or indicators, subsequently to commissioning.

Accordingly, either new fault categories or rules, with corresponding indicators, can be accommodated, and the interpretation unit can thus be adapted to changing properties of the machine.

In an embodiment, the device comprises a user interface, which is configured to output an anomaly outcome or a rule, and/or to receive an adjustment of the anomaly outcome and/or an adjustment of the rule and/or a new rule from a user.

This enables domain knowledge from an expert to be incorporated in the updating of the anomaly detection unit and of rules in the extraction unit.

In an embodiment, the interpretation unit, in the event of a negative anomaly outcome, outputs a confirmation of the normal condition of the machine or a warning instruction with respect to a potential fault, in accordance with indicators and the guideline.

Thus, even in the event of a negative anomaly outcome, potential indications of an impending anomaly can be delivered, or negative anomaly outcomes can be confirmed.

In an embodiment, the adjustment and/or updating of the machine learning model and/or a training of the anomaly interpretation unit and/or the extraction unit are executed in a server unit which is distinct from the machine.

This reduces the processor load in the device, by the outsourcing of compute-intensive processes to the separate server unit. By a server unit having a higher computing capacity, the time required for updating can also be reduced.

According to a further aspect, embodiments of the invention relate to a method for monitoring the condition of a machine, comprising the following steps:
in a machine learning unit (AD):
   reception of sensor data which are collected on the machine during ongoing operation, and which comprise at least one parameter of the machine, and
   ascertainment, on the basis of the sensor data, of an anomaly outcome and of at least one attribute which justifies the anomaly outcome, and execution of the delivery thereof to a transfer unit;
ascertainment by the transfer unit of at least one indicator within the sensor data for the anomaly outcome on the basis of attributes; and
   delivery of the at least one indicator to an interpretation unit (PI); and
verification by the interpretation unit (PI) of the anomaly outcome on the basis of the at least one indicator and a guideline containing rules which comprise at least one allocation of indicators to error types of the machine and which, in the event of a positive anomaly outcome which confirms the anomaly, outputting of a control instruction to be executed on the machine.

In embodiments, the method provides the same advantages as the device.

A further aspect of embodiments of the invention relates to a computer program product (non-transitory computer readable storage medium having instructions, which when executed by a processor, perform actions), comprising a non-volatile computer-readable medium which can be loaded directly into the memory of a digital computer, and comprising program code elements which, upon the execution of program code elements by the digital computer, initiate the implementation by the latter of the steps of embodiments of the method.

Unless indicated otherwise in the following description, the terms “reception”, “ascertainment”, “delivery”, “verification” or similar refer to actions and/or processes and/or processing steps whereby data are modified and/or generated, and/or data are converted into other data wherein, in particular, data can be represented or present in the form of physical variables, for example in the form of electric pulses. The device and units contained therein such as, for example, the machine learning unit, the transfer unit, or similar, can comprise one or more processors and are configured to execute the above-mentioned actions, processes or processing steps.

In embodiments, a processor can be a central processing unit (CPU), a microprocessor or a microcontroller, for example an application-specific integrated circuit or a digital signal processor, potentially in combination with a memory unit for the storage of program commands, etc.

A computer program product such as, e.g., a computer programming means, can be provided or supplied, for example, in the form of a storage medium such as, for example, a memory card, a USB stick, a CD-ROM or a DVD, or in the form of a downloadable file from a network server.

### BRIEF DESCRIPTION

Some of the embodiments will be described in detail, with reference to the following figures, wherein like designations denote like members, wherein:

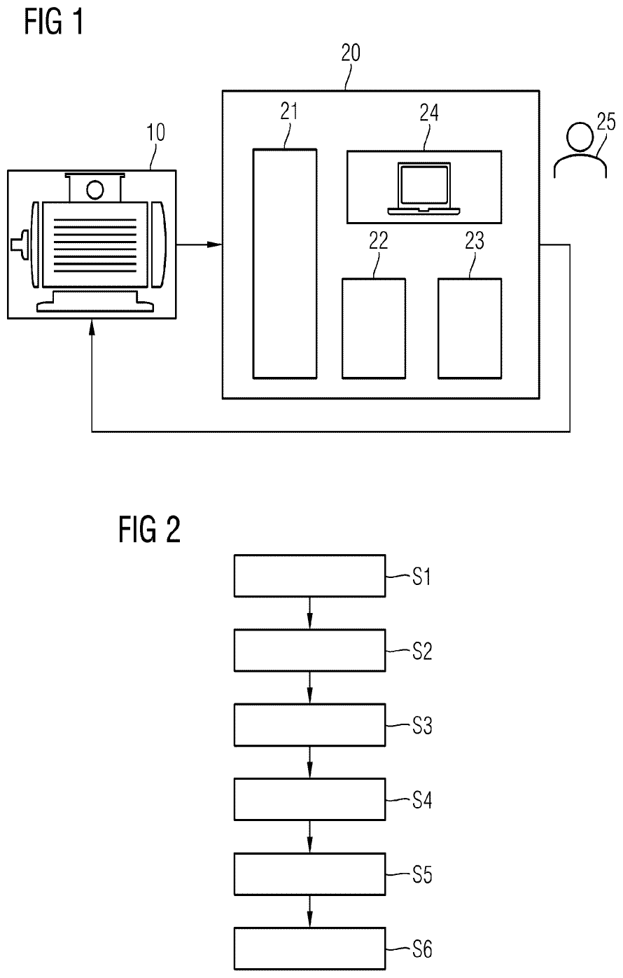

FIG. 1 shows a schematic representation of a first exemplary embodiment of the device in an application environment;

FIG. 2 shows a schematic representation of a detailed view of the exemplary embodiment of the device with its functional units;

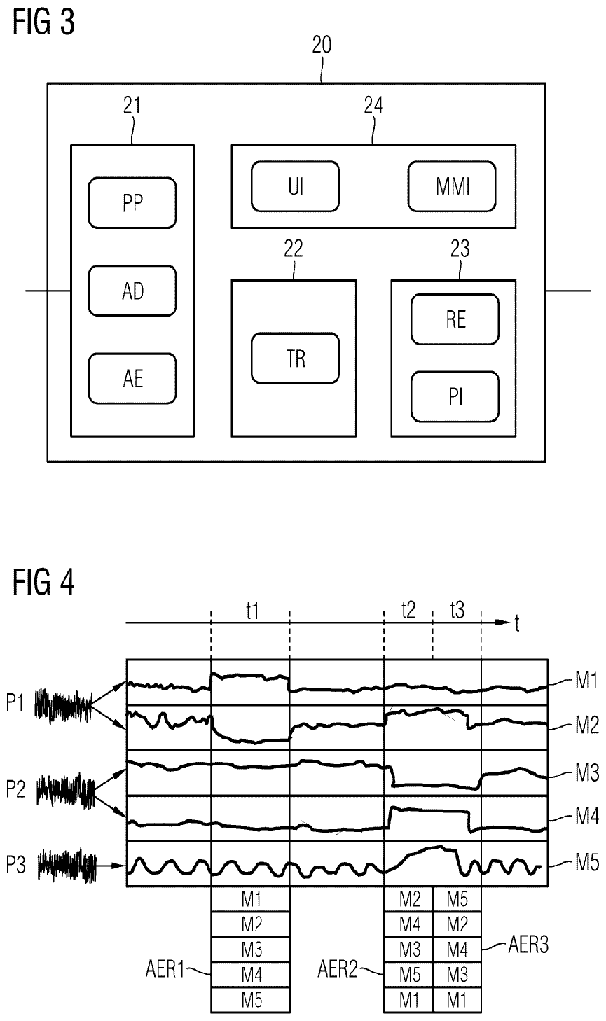

FIG. 3 shows an exemplary embodiment of the method in the form of a flow diagram;

FIG. 4 shows a schematic representation of collected sensor data and the processing thereof by the device according to embodiments of the invention;

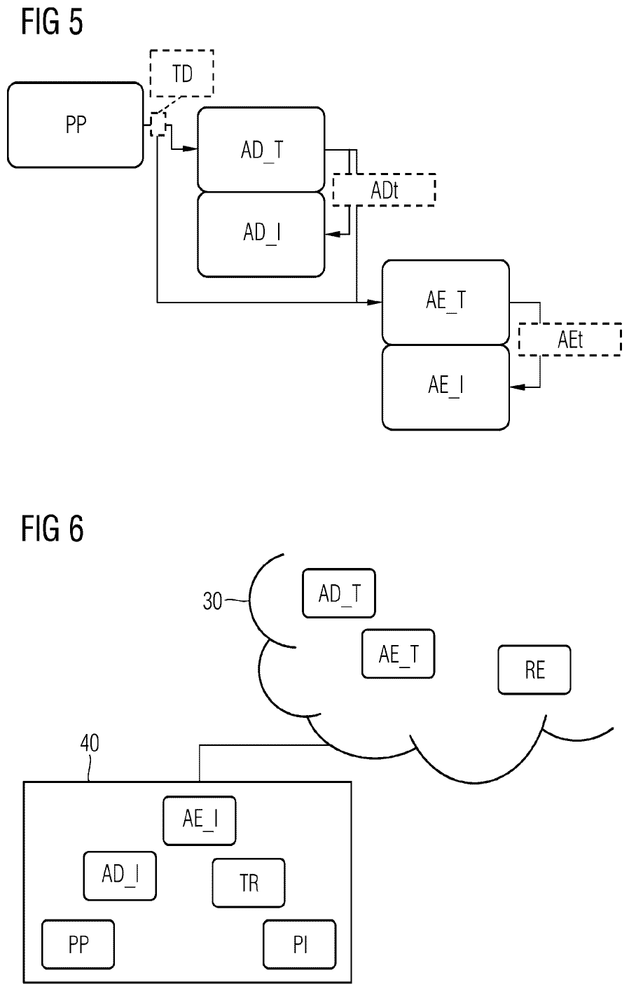

FIG. 5 shows a schematic representation of an initial or repeated training of functional units of the device according to embodiments of the invention; and

FIG. 6 shows a schematic representation of a second exemplary device according to embodiments of the invention, with distinct functional units.

### DETAILED DESCRIPTION

FIG. 1 shows an application scenario in which the condition of a machine 10 is monitored by a monitoring device 20 according to embodiments of the invention.

The machine 10 comprises, for example, one or more machine components of an industrial installation, for example a press, or a milling machine, or a 3D printer or similar, in a production installation, or a pump, a mill or similar in a conveyor or distribution system. On or in the environment of the machine 10, at least one sensor, in general a multiplicity of sensors, is/are arranged, which sensors, in particular, detect physical parameters of the machine 10 and output a sensor signal with sensor data.

The monitoring device 20, also described hereinafter as a device 20, for short, assumes a modular structure and comprises a machine learning unit 21, in which at least one learning model for anomaly detection and for further analytical functions is implemented. The monitoring device 20 moreover comprises an interpretation unit 23, in which domain knowledge, including potential anomalies and potential causes of faults are retrievably logged in an abstract form. The device 20 comprises a transfer unit 22, which processes outcomes and information from the machine learning unit 21 for physical interpretation by the interpretation unit 23.

The device 20 comprises an input/output interface 24, which provides a user interface for a user 25, for example a domain expert or a machine operator, for the input and output of data, in particular for the output of an anomaly outcome or a rule, and/or for the input of a variation of the anomaly outcome or rule and/or for the input of new rules. Via the user interface, control instructions which are ascertained by the interpretation unit 23 can be output, for example, to the machine operator for execution on the machine. In an embodiment, the input/output unit 24 comprises a data interface via which control instructions are communicated directly to the machine.

Process steps executed by the device 20 are described with reference to FIG. 2. In a first process step S1, the machine learning unit 21 receives sensor data from the machine 10, which has been collected during the ongoing operation of the machine 10. Sensor data thus includes data for at least one, customarily for a multiplicity of different parameters of the machine 10. In addition to physical parameters, such as a temperature, a pressure, or similar, sensor information can also comprise indications of a filling level of a production resource or a production material of the machine 10, or images generated from the operation of the machine 10.

In the next step S2, in accordance with the sensor data, the machine learning unit ascertains an anomaly outcome and at least one attribute which justifies the anomaly outcome, and is indicative of an anomaly in force, and executes the communication thereof to a transfer unit 22.

In the transfer unit 22, at least one indicator is ascertained within the sensor data, on the basis of attributes thus communicated—see S3—and is communicated to the interpretation unit 23. Herein, the anomaly outcome is verified on the basis of the at least one indicator and a guideline containing rules that comprise at least one allocation of indicators to error types of the machine—see step S5. In the event of a positive anomaly outcome which indicates an abnormal condition of the machine, on the basis of the error type thus ascertained, a control instruction is output for execution on the machine 10—see step S6. In the event of a negative anomaly outcome, the interpretation unit outputs a confirmation of the normal condition of the machine or a warning instruction with respect to a potential force, according to the series of indicators and the guideline.

The machine learning unit thus delivers not only the anomaly outcome, which indicates whether the monitored machine is in a normal operating condition, also described hereinafter as good working order, or whether a poor condition is in force, which deviates from a normal operating condition, but also delivers those attributes, for example a specific combination of sensor data parameters, which have given rise to this anomaly outcome. The transfer unit translates attributes into the “language” of the interpretation unit. For one attribute, for example, the indicator expresses the characteristic of parameters A and B which are contained therein over a given time period, for example and “abrupt rise in parameter A”, and an “average value of parameter B”. On the basis of these physically interpretable indicators and the guideline, a control instruction can thus be output. The control instruction is based upon error types of the machine, and thus delivers targeted and specific proposals for action to a machine operator, or control commands to a control unit of the machine. Outcomes from the data-based machine learning unit are thus translated into physical phenomena and are represented by the interpretation unit on the basis of fault conditions and the elimination thereof.

The individual units of the monitoring device 20 and the functional units thereof are described in greater detail with reference to FIG. 3. The machine learning unit 21 comprises a data processing unit PP, an anomaly detection unit AD and an anomaly interpretation unit AE. The transfer unit 22 comprises a transfer function TR. The interpretation unit 23 comprises an extraction unit RE and the interpretation function PI. The input/output 24 interface comprises the above-mentioned user interface UI and the data interface MMI.

The data processing unit PP receives raw data which are measured on the machine in a temporal sequence and subdivides raw data into temporal processing stages, converts the data format thereof, if necessary, consolidates multiple raw data components into a single parameter, and outputs the latter to the machine learning unit.

The data processing unit PP receives sensor data via the data interface MMI, which are input in the form of raw data, and converts the latter into a vectoral input signal for the anomaly detection unit AD. This means that sensor data points are present in the form of a data vector. Raw data received in the data processing unit PP are signals from at least one, and typically from a plurality of sensors. These sensors, for example, execute periodic measurements and, at each measuring time point, deliver a single-or multidimensional measuring point by way of a sensor datum, for example an image, a spectrum, a hyperspectral image or a scalar variable, such as current or voltage. A measurement rate of sensors can differ, such that sensor data are not necessarily generated synchronously. Independently of the modality and dimensionality of input data, the magnitude of sensor data does not vary during the operation of the machine 10. For example, image or spectral resolution remains constant during operation. Moreover, the data processing unit PP subdivides raw data into temporal processing stages, in accordance, for example, with a temporal characteristic of raw data values or sensor data values.

The data processing unit PP, if required, adjusts a sub-volume of raw data, the input rate of which deviates from an output rate to the output rate. In the case of raw data, the measurement rate or input rate of which is not equal to the output rate, an adjustment of the sampling rate is executed. This can be achieved, for example, by linear interpolation, feedback of the most recent value, multi-rate filtering, for example (low-pass) filtering and variation of the scanning rate, segmentation of the sensor data input signal into time values and mean-value generation. Sensor data which has been received between the previous and the present output time point is averaged accordingly. Calculation then proceeds on the basis of this averaged value.

In each of the above-mentioned cases, averaging is executed over time. This arrangement can thus be applied even to multidimensional sensor signals such as, for example, spectra or images. As a result, a synchronized signal rate of all sensor signals is ensured, i.e., at any time point at which the calculation of an output signal is intended, the values of all input signals are available. The output signal of the data processing unit PP is a data vector which incorporates relevant elements for the anomaly detection unit AD. The output rate is a predetermined value and corresponds to the rate at which anomaly detection is executed. Moreover, temporal processing stages are ascertained in accordance with the temporal characteristic of sensor data values. Temporal processing stages are time intervals in which each of the various sensor data parameters assume an identical characteristic. For example, an alteration of the temporal characteristic of at least one parameter generates the set-up of a new temporal processing stage. Temporal processing stages can thus be of differing time lengths.

The input signal of the anomaly detection unit AD is the data vector. This assumes a length which is predetermined and fixed for the specific application, in the present case the monitoring of the machine 10. Components of the input vector can be formed from unprocessed sensor data in various ways. These can be output data of the data processing unit PP, or can be raw sensor data which are received directly from the machine 10. The output signal of the anomaly detection unit AD is the anomaly outcome. The anomaly outcome is a binary value, which indicates whether or not an anomaly has been detected. A new value is generated immediately when a new input vector is in force, i.e., the input and output assume the same updating rate.

The function of the anomaly detection unit AD is executed by machine learning. A sufficient number of samples of the input vector which describe the routine operation of the machine 10 are available for this purpose. In the event of a cold start of the monitoring device 20, with no preliminary training of the machine learning unit 21 on the machine 10, a limited initial base volume of sensor data or input vectors is sufficient for the constitution of an initial data series. From this initial data series, the property incorporated in sensor data is learned which delimits non-anomaly cases, i.e., good conditions, from anomaly cases, i.e., poor conditions.

The anomaly detection unit AD is for example configured as an unsupervised machine learning model, in particular in the form of an autoencoder or an Isolation Forest One-Class Support Vector Machine, or as a method for outlier detection. The anomaly outcome is output in the form of a binary value, which is ascertained in accordance with a calculated anomaly value and a limiting value wherein, in particular, the limiting value is established by reference to an empirical distribution of the anomaly value for non-anomaly data. Alternatively, the anomaly outcome is output in the form of a weighting, which indicates a degree of prominence of the anomaly.

The anomaly value, which is output by the anomaly detection unit AD, also described as the anomaly score, of the machine learning model is translated by a limiting value, also described as a threshold value, into a binary variable, or is relayed in the form of a “weighting” which indicates a “prominence” of the anomaly. In an exemplary embodiment, the threshold value is determined by reference to a predetermined p-value, i.e., an overshoot probability or a significance value, and an empirical distribution of the anomaly value for non-anomaly data.

The anomaly interpretation unit AE, in an initial step, requires access to the trained machine learning model of the anomaly detection unit AD and access to the training data employed for training. By way of an input signal, the anomaly interpretation unit AE receives the anomaly outcome and sensor data from the fundamental processing stage. The anomaly interpretation unit AE comprises an interpretable artificial intelligence method, for example a machine learning model configured in the form of a tree structure, by which decisions of the anomaly detection unit AD can be represented in a reproducible manner. The output signal of the anomaly interpretation unit AE is comprised of attributes, which are sorted according to their relevance for the decision of the anomaly detection unit AD.

By reference to a temporal characteristic of sensor data of the machine 10, FIG. 4 shows one example of an output signal of the anomaly interpretation unit AE. Sensor data measured on the machine 10 comprises a parameter P1, for example a measured force, a parameter P2, for example a pressure, and a parameter P3, for example a temperature of the machine. From the sensor data P1, an attribute M1 and M2 is calculated, for example a force which is averaged over a predetermined time interval, and a standard deviation of the force. From parameter values for P2, in the same manner, an average pressure and a standard deviation of pressure are ascertained as attributes M3 and M4. Temporal processing stages have been ascertained by the data processing unit PP. For processing stage t1, the anomaly interpretation unit AE outputs an output signal AER1. The sequence in which the attributes M1 . . . , M5 are output in the output signal AER1 indicates the relevance of these attributes to the ascertainment of the anomaly outcome by the anomaly detection unit AD. In the output signal AER1, attribute M1 has the highest relevance. The relevance of the subsequent attributes M2, M3, M4, M5 declines vis-à-vis the respectively preceding attribute. In the same manner, the output signals AER2 and AER3 are output for the temporal processing stages t2, t3. The temporal processing stages can be of different lengths, i.e., duration. Whereas, in processing step t2, attribute M2 has had the greatest influence upon the anomaly outcome, attribute M5 is of the greatest relevance in processing stage t3.

In an embodiment, the temporal processing stages are of constant length. In a further variant of embodiment, more than one output signal can be output for a temporal processing stage. In embodiments, this is the case in the event of a minor difference in relevance between two output signals. Thus, in FIG. 4, for a single temporal processing stage t4, which comprises the temporal processing stages t2 and t3, two output signals, in this case the output signals AER2 and AER3 might be output.

The transfer unit 21, and the transfer function TR contained therein, by way of an input signal, receives attributes which have been “interpreted” by the anomaly interpretation unit AE and which, in the anomaly detection unit AD, have resulted in the “anomaly” decision. The transfer function TR additionally receives sensor data from the fundamental processing stage and, optionally, additionally receives sensor data from adjacent processing stages, by way of an input signal. The transfer function translates this information into a “physically interpretable language”, i.e., into at least one, and generally into a series of indicators, which describe the rules which have been generated from the extraction unit RE. An indicator essentially constitutes a trend vis-à-vis a good working order, i.e., a behavior of an attribute such as, e.g., a substantial rise, failure, oscillation, decay, or similar.

The output signal of the transfer unit 21 is the series of indicators described, which explain why the anomaly detection unit AD has been led to the outcome “anomaly”. In some embodiments, the transfer unit 22 relays the output signals of the anomaly interpretation unit AE, and thus the ranking of attributes according to their contribution to the present anomaly, to the interpretation unit 23.

The interpretation function PI of the interpretation unit 23, by way of an input signal from the transfer unit 22, receives the at least one indicator. The interpretation function PI checks the anomaly outcome on the basis of the at least one indicator and a guideline containing rules which comprise at least one allocation of indicators to error types of the machine. Thereafter, by way of an output signal, the interpretation function PI delivers feedback, either to the effect that a good working order is actually in force, for example one or more permissible operating states, or to the effect that an anomaly state is actually in force. A control instruction which is saved in the interpretation function PI, for example a recommended action, is fed back via the user interface UI of the input/output unit 24 to a machine operator or is fed back as an automatic response via the data interface MMI to the machine 10.

By the extraction unit RE, physically based error descriptions are communicated to the monitoring device. Input signals from the extraction unit RE are received. In an exemplary embodiment, the extraction unit RE infers rules and indicators based upon expert knowledge, textbook knowledge, physical analytical description, or information from a digital twinning of the machine.

The “output signal” of the extraction unit RE is a list of rules which are saved in the interpretation function PI.

If required, the monitoring device 20 can be recalibrated at any time and in a simple manner. Instructions to the effect that recalibration is necessary are delivered by the monitoring unit 20 itself. For example, the anomaly detection unit AD might identify numerous anomalies, none of which can be allocated to a known rule by the interpretation function PI. In the event of a verification on the machine 10 of a novel fault, or a novel instance of a known fault, an adjustment/redrafting of a rule in the extraction unit RE is indicated. The interpretation unit 23 is configured to receive and/or update further rules and/or indicators, subsequently to commissioning.

In the event of a verification on the machine 10 of impeccable operation, but also of potential changes in the environment, an adjustment of the machine-based model in the anomaly detection unit AD, for example by retraining, is indicated. In an exemplary embodiment, the machine learning model is adjusted at predetermined time intervals during the operation of the machine.

The monitoring device of the above-mentioned design can be set up and operated for the monitoring of different machines. For example, a set-up, commissioning and operating phase of the monitoring device 20 for monitoring a hydraulic press can be described. Sensors on the machine ascertain a pressure and a force, each at a sampling frequency of 1 kHz, and a press temperature and ambient temperature of the press, at a sampling frequency of 1/60 Hz.

During the set-up phase of the monitoring device 20 for monitoring the press, the following operations are executed—see FIG. 5:

The data processing device PP is configured to receive sensor data from the above-mentioned data sensors, which data are input at different sample rates and, for example, for the pressure and force respectively, to ascertain herefrom a mean value and a variance over a time window of one minute, together with the press temperature, in order to reduce the ambient temperature, and to execute the output thereof as attributes, at a uniform output rate of 1/10 Hz.

An input format of the anomaly detection unit AD is adjusted to the output format and the output rate of the data processing unit PP. The anomaly detection unit AD comprises a training variant and an inference variant of a machine learning model AD_T, AD_I. The training variant AD_T, using sensor data/training data TD which have been collected under a normal operating condition of the press, is trained in the normal operating condition of the press, and outputs an anomaly outcome. The trained model of the training variant AD_T is output, and is employed as the inference variant AD_I. By way of input signal, the inference variant receives the processed data, and outputs an anomaly outcome in the form of a binary value (true/false) for each input value.

The anomaly interpretation unit AE comprises a training variant and an inference variant of a machine learning model AE_T, AE_I. The training variant AE_T is trained on the basis of the trained learning model of the anomaly detection unit AD, and all sensor data which are available up to the time point of the training of the anomaly interpretation unit AE. The training variant AE_T identifies the respective importance of each combination of attributes for a given instance of the anomaly outcome. The inference variant AE_I assumes the model of the training variant AE_T, and is a function which, for a given data vector and anomaly outcome by way of an input signal, outputs a list of attribute combinations, which are ordered according to their significance for the identification of the data vector as an anomaly.

The transfer function TR translates the output attributes of attribute combinations into “physical” expressions such as, for example, “normal, too high, too low, rising, stable, declining”, such that these expressions can be compared with expressions in the rules. To this end, the transfer function TR employs, by way of an input signal, the respective importance of an attribute to the data vector at a considered time point tx, together with training data within a specific time period prior to the considered time point tx. All non-relevant attributes are classified as “normal”. For all relevant attributes, the status and trend thereof are calculated by the employment of training data and historical data by way of a reference. For example, the temperature trend is calculated, wherein the temperature in the preceding hour is considered. The mean force is ascertained on the basis of mean force values in the training data.

The extraction unit RE is populated with rules based upon information from a domain expert in presses, including qualitative characteristics for typical fault behaviors of the press. Information such as, for example: “Cooling fault results in a consistent rise in temperature and a loss of press pressure” is translated into a rule for “cooling faults” in the form of “Rising temperature trend, mean pressure lower than normal”.

The interpretation function PI is configured to retrieve rules from the extraction unit. The interpretation function PI defines a matching function which, for example, by a distance function, ascertains a margin between an anticipated fault behavior and a present observation. An input signal for the interpretation function PI is a present physical state, i.e., an indicator for the press and an anticipated physical state for various fault types. Output signals are fault candidates which are ordered according to significance.

Further to the set-up phase, units and functions of the monitoring device 10, in the commissioning phase, i.e., within an adaptation time period, can be brought into service in an as yet untrained state vis-à-vis the press. In the commissioning phase, also described as a cold start, the data processing unit PP is already active. The monitoring device 20 can be employed, without further calibration, in actual service. A precondition for this purpose is that the pump is in good working order. The monitoring device 20 firstly collects data, with no further evaluation and received with a predetermined time interval, which is either predetermined in a fixed manner or is defined by a user and receives an initial command for “start (re-)training”. If suspected fault cases are already in force, the expert/user, via the user interface, is requested to assign rule and labels/a classification for these cases.

The training variants AD_T of the anomaly detection unit are trained using these data and are transferred in the form ADt to the inference variant AD_I and to the training variants AE_T of the anomaly interpretation unit—see FIG. 5. The anomaly detection unit AE_I is now active and evaluates sensor data which are collected on the pump. The training variant AE_T of the anomaly interpretation unit is trained by reference to the training variant AD_T of the anomaly detection unit and is transferred to the inference variant AE_I—see AEt in FIG. 5.

In the subsequent operating phase, sensor data which are collected on the pump during the operation thereof are processed by the monitoring device, as described above, which outputs a control instruction. In the event that a condition evaluated by the machine operator differs from that evaluated by the monitoring device 20, the machine operator, via the user interface, can enter a modified classification of the data point, execute the addition thereof to the training data, as further training data, and, optionally, initiate a retraining of the anomaly detection unit AD. This is executed as described above for the commissioning phase—see FIG. 5. In the event of a change in the fault behavior of the pump during the operating phase, one or more rules can be updated, deleted or added by the extraction unit RE.

Units of the monitoring system can be implemented in a single physical unit. However, they can also be arranged in different physical units, for example in a system unit 40 in physical proximity to the monitored machine, and in a separate server unit 30, for example a cloud—see FIG. 6. Both the training variant and the inference variant of the anomaly detection unit AD_T. AD_I and of the anomaly interpretation unit AE_T. AE_I can be operated as standalone components. In embodiments, it is advantageous that the training variant of the anomaly detection unit AD_T, the training variant of the anomaly interpretation unit AE_T and the extraction unit RE are trained and operated in the separate server unit 40. Compute-intensive operations, which are not associated with the present evaluation of the condition of the machine, can be outsourced accordingly. Units required for the evaluation of sensor data, in particular the data processing unit PP, the inference variants of the anomaly detection unit and the anomaly interpretation unit AD_I, AE_I, the transfer function TR and the interpretation function PI are arranged in embodiments of the system unit 40.

The monitoring device can be brought into service with no complex collection of data, and continuously adapted. By simple and rapidly implemented interactions, the monitoring device can be continuously notified as to whether a modification thereof is required, for the purposes of adaptation. Once the monitoring device has been commissioned on one machine, it can be employed, without modification, for the monitoring of other equivalent machines. Only the retraining or adaptation of the anomaly detection unit will be required. Rules can be modified by the extraction unit RE, in the event of a change of machine type.

All process steps can be implemented by the corresponding devices, which are appropriate for the execution of the respective process steps. All functions which can be executed by the features described herein can constitute a process step of embodiments of the method.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A monitoring device for monitoring the condition of a machine, comprising:
a machine learning unit, comprising an anomaly detection unit having a trained machine learning model, which is configured to receive sensor data which are collected on the machine during ongoing operation, and which comprise at least one parameter of the machine, and which, on the basis of the sensor data, ascertains an anomaly outcome and at least one parameter of the sensor data which is sorted according to a relevance thereof to the anomaly outcome, as an attribute which justifies the anomaly outcome, and executes a delivery thereof to a transfer unit;
the transfer unit, which is configured to ascertain at least one indicator within the sensor data for the anomaly outcome on the a basis of at least one attribute, and to deliver the at least one indicator to an interpretation unit; and
the interpretation unit, which is configured to verity the anomaly outcome on a basis of the at least one indicator and a guideline comprising rules which comprise at least one allocation of indicators to error types of the machine and, in an event of a positive anomaly outcome which confirms the anomaly, to output a control instruction which is to be executed on the machine,
wherein the transfer unit receives sensor data for a fundamental processing stage and/or an additional sensor data for an adjacent processing stage, by way of an input signal, and ascertains the at least one indicator herefrom for those attributes having a highest relevance.

2. The device as claimed in claim 1, wherein the trained machine learning model, by reference to sensor data which have been logged on the machine in normal operation during a predetermined adaptation period, further to commissioning, is adapted to the machine which is to be monitored.

3. The device as claimed in claim 2, wherein the machine learning model is adapted at predetermined time intervals during the operation of the machine.

4. The device as claimed in claim 1, wherein the anomaly outcome is output in the form of a binary value, which is dependent upon a calculated anomaly value, and a limiting value is ascertained wherein the limiting value is established by reference to an empirical distribution of the anomaly value for non-anomaly data, or the anomaly outcome is output in the form of a weighting, which indicates a degree of prominence of the anomaly.

5. The device as claimed in claim 1, wherein the machine learning unit comprises a data processing unit which, in a temporal sequence, receives raw data which are measured on the machine and subdivides raw data into temporal processing stages and/or converts the data format thereof and/or consolidates multiple components of raw data into a single parameter, and executes the output thereof to the machine learning unit.

6. The device as claimed in claim 5, wherein the data processing unit harmonizes a sub-volume of raw data, an input rate of which deviates from an output rate of sensor data, with the output rate.

7. The device as claimed in claim 5, wherein the machine learning unit comprises an anomaly interpretation unit which, by way of an input signal, receives the anomaly outcome and sensor data for the at least one fundamental processing stage and which, by way of attributes, outputs sensor data parameters to the transfer unit which are sorted according to their relevance to the anomaly outcome.

8. The device as claimed in claim 1, wherein the interpretation unit comprises an extraction unit, which is configured to infer rules and indicators based upon expert knowledge, textbook knowledge, physical analytical description or a digital twinning of the machine, and to execute the delivery thereof to the interpretation function, prior to the commissioning of the device.

9. The device as claimed in claim 1, wherein the interpretation unit is configured to receive and/or update further rules and/or indicators, subsequently to commissioning.

10. The device as claimed in claim 1, comprising a user interface, which is configured to output an anomaly outcome or a rule, and/or to receive an adjustment of the anomaly outcome and/or an adjustment of the rule and/or a new rule from a user.

11. The device as claimed in claim 1, wherein the interpretation unit, in an event of a negative anomaly outcome, outputs a confirmation of the normal condition of the machine or a warning instruction with respect to a potential fault, in accordance with a series of described indicators and the guideline.

12. The device as claimed in claim 1, wherein the adjustment and/or updating of the machine learning model and/or a training of the anomaly interpretation unit are executed in a distinct server unit.

13. A method for monitoring the condition of a machine, comprising the following:
in a machine learning unit which comprises an anomaly detection unit having a trained machine learning model:
reception of sensor data which are collected on the machine during ongoing operation, and which comprise at least one parameter of the machine;
ascertainment, on a basis of the sensor data, of an anomaly outcome and of at least parameter of the sensor data which is sorted according to a relevance thereof to the anomaly outcome, by way of an attribute which justifies the anomaly outcome, and execution of the delivery thereof to a transfer unit;
ascertainment by the transfer unit of at least one indicator within the sensor data for the anomaly outcome on a basis of attributes; and
delivery of the at least one indicator to an interpretation unit; and
verification by the interpretation unit of the anomaly outcome on a basis of the at least one indicator and a guideline comprising rules which comprise at least one allocation of indicators to error types of the machine; and
in an event of a positive anomaly outcome which confirms the anomaly, outputting of a control instruction to be executed on the machine,
wherein the transfer unit receives sensor data for the fundamental processing stage and/or additional sensor data for an adjacent processing stage, by way of an input signal, and ascertains the at least one indicator herefrom for those attributes having a highest relevance.

14. A computer program product, comprising a computer readable hardware storage device having computer readable program code stored therein the program code executable by a processor of a computer system to implement a method, as claimed in claim 13.
